(19) United States
(12) Patent Application Publication
(10) Pub. No.: US 2026/0321912 A1
(43) Pub. Date: Oct. 15, 2026

(54) METHOD FOR PRODUCING ENERGY STORAGE DEVICE, AND ENERGY STORAGE DEVICE

(71) Applicant: GS Yuasa International Ltd., Kyoto-shi (JP)

(72) Inventor: Hironori AIDA, Kyoto-shi (JP)

(21) Appl. No.: 19/687,288

(22) Filed: May 26, 2026

Related U.S. Application Data
(63) Continuation of application No. PCT/JP2024/041376, filed on Nov. 22, 2024.

(30) Foreign Application Priority Data
Dec. 1, 2023 (JP) 2023-204097

(51) Int. Cl. H01M 50/536; B23K 26/21; B23K 101/38; H01M 4/70; H01M 10/0587

(52) U.S. Cl. CPC H01M 50/536; H01M 4/70; H01M 10/0587; B23K 26/21; B23K 2101/38

(57) ABSTRACT

A method for producing an energy storage device including an electrode assembly including a first plate and a second plate, a first current collector joined to the first plate, and a second current collector joined to the second plate, includes forming a first joint portion by clamping and joining the first plate and the first current collector from both sides, and forming a second joint portion by joining the second plate and the second current collector from one side.

### CROSS REFERENCE TO RELATED APPLICATIONS

This application claims the benefit of priority to Japanese Patent Application No. 2023-204097 filed on Dec. 1, 2023 and is a Continuation Application of PCT Application No. PCT/JP2024/041376 filed on Nov. 22, 2024. The entire contents of each application are hereby incorporated herein by reference.

### BACKGROUND OF THE INVENTION

### 1. Field of the Invention

The present invention relates to methods for producing energy storage devices and also relates to energy storage devices.

### 2. Description of the Related Art

JP-A-2018-190547 discloses a secondary battery including a stacked-type electrode assembly in which a plurality of positive electrode sheets and a plurality of negative electrode sheets are stacked, the positive electrode sheets and a positive electrode current collector terminal being laser-welded, and the negative electrode sheets and a negative electrode current collector terminal being laser-welded.

### SUMMARY OF THE INVENTION

In the above conventional secondary battery, the positive electrode sheet and the positive electrode current collector terminal are joined by laser welding by irradiating the positive electrode sheet and the positive electrode current collector terminal with a laser from outside, and the negative electrode sheet and the negative electrode current collector terminal are joined by laser welding by irradiating the negative electrode sheet and the negative electrode current collector terminal with a laser from outside. However, during the joining operation, depending on the state and the like of a joining location, joining by laser welding is not suitable in some cases. For this reason, improvement in flexibility of the joining operation is desired.

Example embodiments of the present invention provide methods for producing energy storage devices and energy storage devices that each improve flexibility in a joining operation between an electrode assembly and a current collector.

A method for producing an energy storage device according to an example embodiment of the present invention is a method for producing an energy storage device including an electrode assembly including a first plate and a second plate, a first current collector joined to the first plate, and a second current collector joined to the second plate, the method including forming a first joint portion by clamping and joining the first plate and the first current collector from both sides, and forming a second joint portion by joining the second plate and the second current collector from one side.

An energy storage device according to an example embodiment of the present invention includes an electrode assembly including a first plate and a second plate, a first current collector joined to the first plate, and a second current collector joined to the second plate, in which the first plate and the first current collector include a first joint portion joined by resistance welding or ultrasonic bonding, and the second plate and the second current collector include a second joint portion joined by laser welding.

According to the methods for producing energy storage devices and the like of example embodiments of the present invention, flexibility in the joining operation between the electrode assembly and the current collector can be improved.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing the appearance of an energy storage device according to an example embodiment of the present invention.

FIG. 2 is a perspective view showing an internal configuration of a case of an energy storage device according to an example embodiment, with a case body separated from the case.

FIG. 3 is a perspective view showing an internal configuration of the case in an energy storage device according to an example embodiment, as viewed from the side opposite to FIG. 2.

FIG. 4 is an exploded perspective view showing, in an exploded manner, each element other than a case body in an energy storage device according to an example embodiment of the present invention.

FIG. 5 is a flowchart showing producing steps in a method for producing an energy storage device according to an example embodiment of the present invention.

FIG. 6 is a perspective view showing a step of attaching a current collector to a terminal in a method for producing an energy storage device according to an example embodiment of the present invention.

FIG. 7 is a perspective view showing a step of forming a first joint portion in a method for producing an energy storage device according to an example embodiment of the present invention.

FIGS. 8A to 8C are cross-sectional views showing a step of forming a first joint portion in a method for producing an energy storage device according to an example embodiment of the present invention.

FIGS. 9A and 9B are perspective views showing a step of bending a first plate and a step of bending a second plate in a method for producing an energy storage device according to the example embodiment of the present invention.

FIGS. 10A and 10B are perspective views showing a step of forming a second joint portion in a method for producing an energy storage device according to an example embodiment of the present invention.

FIG. 11 is a plan view showing an example of an energy storage apparatus according to a modification example of an example embodiment of the present invention.

### DETAILED DESCRIPTION OF THE EXAMPLE EMBODIMENTS

(1) A method for producing an energy storage device according to an example embodiment of the present invention is a method for producing an energy storage device including an electrode assembly including a first plate and a second plate, a first current collector joined to the first plate, and a second current collector joined to the second plate, the method including forming a first joint portion by clamping and joining the first plate and the first current collector from both sides, and forming a second joint portion by joining the second plate and the second current collector from one side.

According to a method for producing the energy storage device according to an example embodiment of the present invention, the method includes forming a first joint portion by clamping and joining the first plate and the first current collector from both sides, and forming a second joint portion by joining the second plate and the second current collector from one side. As described above, the first joint portion and the second joint portion are formed by different joining methods, namely, the first joint portion is formed by clamping and joining the first plate and the first current collector from both sides, and the second joint portion is formed by joining the second plate and the second current collector from one side. As a result, during the joining operation, the electrode assembly and the current collector can be joined by selecting a joining method suitable for the state and the like of a joining location, and therefore, flexibility in the joining operation between the electrode assembly and the current collector can be improved.

(2) In the method for producing the energy storage device according to (1), the forming of the first joint portion includes forming the first joint portion at one end portion of the electrode assembly in a predetermined direction, and, the forming of the second joint portion includes, after the forming of the first joint portion, forming the second joint portion at the other end portion of the electrode assembly in the predetermined direction.

According to the method for producing the energy storage device described in (2), after the first joint portion is formed at one end portion of the electrode assembly, the second joint portion is formed at the other end portion of the electrode assembly. Here, in the forming of the first joint portion, because the first plate and the first current collector are clamped and joined from both sides, during the joining operation, it is necessary to secure spaces on both sides of the first plate and the first current collector. In the forming of the second joint portion, because the second plate and the second current collector are joined from one side, during the joining operation, it is sufficient to secure a space on one side of the second plate and the second current collector. In a configuration in which the joint portions are formed at both end portions of the electrode assembly, a space is more easily secured by performing the joining operation first. Therefore, the second joint portion is formed after the first joint portion is formed. In other words, the first joint portion is formed before the second joint portion is formed. As a result, in the forming of the first joint portion, the joining operation can be performed in a state in which spaces are secured on both sides of the first plate and the first current collector. Therefore, flexibility in the joining operation between the electrode assembly and the current collector can be further improved.

(3) In the method for producing the energy storage device according to (2), the method may further include bending the first plate after the forming of the first joint portion, and the forming of the second joint portion may be performed after the bending of the first plate.

According to the method for producing the energy storage device described in (3), the bending of the first plate is performed after the first joint portion is formed, and the second joint portion is formed after the bending of the first plate. As described above, by bending the first plate after the first joint portion is formed, the second plate can be brought close to the second current collector in the forming of the second joint portion. As a result, the joining operation of the second plate and the second current collector can be facilitated, and therefore the second joint portion can be formed easily. Therefore, flexibility in the joining operation between the electrode assembly and the current collector can be further improved.

(4) In the method for producing the energy storage device according to (3), the method may further include bending the second plate, and the forming of the second joint portion may be performed after the bending of the second plate.

According to the method for producing the energy storage device described in (4), the second joint portion is formed after the bending of the second plate is performed. As described above, by bending the second plate, the second plate can easily be brought close to the second current collector in the forming of the second joint portion. As a result, the joining operation of the second plate and the second current collector can be further facilitated, and therefore, the second joint portion can be formed more easily.

(5) In the method for producing the energy storage device according to any one of (1) to (4), the first plate may be a positive electrode plate, the second plate may be a negative electrode plate, the first current collector may be a positive electrode current collector, and the second current collector may be a negative electrode current collector.

According to the method for producing the energy storage device described in (5), the first joint portion is formed by clamping and joining the positive electrode plate as the first plate and the positive electrode current collector as the first current collector from both sides, and the second joint portion is formed by joining the negative electrode plate as the second plate and the negative electrode current collector as the second current collector from one side. Here, at the time when the joining operation is performed while the device is reached from one side, because a large load is difficult to apply, there is a risk that a joining defect occurs. The risk of the joining defect possibly becomes more pronounced in a case where the positive electrode plate is joined. Accordingly, by clamping and joining the positive electrode plate as the first plate and the positive electrode current collector as the first current collector from both sides, the risk can be reduced while improving flexibility in the joining operation between the electrode assembly and the current collector.

(6) An energy storage device according to an example embodiment of the present invention includes an electrode assembly including a first plate and a second plate, a first current collector joined to the first plate, and a second current collector joined to the second plate, in which the first plate and the first current collector include a first joint portion joined by resistance welding or ultrasonic bonding, and the second plate and the second current collector include a second joint portion joined by laser welding.

According to an energy storage device according to an example embodiment of the present invention, the first plate and the first current collector include the first joint portion joined by resistance welding or ultrasonic bonding, and the second plate and the second current collector include the second joint portion joined by laser welding. As described above, the first joint portion and the second joint portion are formed by different joining methods. As a result, during the joining operation, the electrode assembly and the current collector can be joined by selecting a joining method suitable for the state and the like of a joining location, and therefore, flexibility in the joining operation between the electrode assembly and the current collector can be improved.

Hereinafter, with reference to the drawings, a method for producing an energy storage device and an energy storage device according to example embodiments of the present invention (including modification examples of the example embodiment) will be described. The example embodiments described below each illustrate a comprehensive example or a specific example. Numerical values, shapes, materials, elements, arrangement positions and connection forms of the elements, producing steps, order of the producing steps, and the like that are shown in the following example embodiments are merely examples and are not intended to limit the present invention. In each drawing, dimensions and the like are not illustrated exactly. In each drawing, identical or the same elements are denoted by the same reference signs.

In the following description and drawings, the direction in which a pair of short side surfaces oppose each other in a case of the energy storage device, the arrangement direction of a pair of terminals (a positive electrode and a negative electrode; the same applies hereinafter) included in the energy storage device, the arrangement direction of a pair of current collectors, the winding axis direction of the electrode assembly, or the arrangement direction of the first joint portion and the second joint portion are each defined as the X-axis direction. The thickness direction of the case (the direction in which the width becomes smallest; the same applies hereinafter), the direction in which a pair of long side surfaces oppose each other in the case, the arrangement direction of two electrode assemblies, or the thickness direction of one electrode assembly are each defined as the Y-axis direction. The arrangement direction of a case body and a lid of the case, the arrangement direction of the electrode assembly and the terminal, the direction in which the terminal protrudes from the case, or the up-down direction are each defined as the Z-axis direction. The X-axis direction, the Y-axis direction, and the Z-axis direction are directions intersecting each other (orthogonal in the present example embodiment). Depending on a usage mode, it is conceivable that there is a case where the Z-axis direction is not the up-down direction, but the following description will be given with the Z-axis direction as the up-down direction for convenience of description.

In the following description, the X-axis positive direction indicates the arrow direction of the X-axis, and the X-axis negative direction indicates a direction opposite to the X-axis positive direction. In the case of simply referred to as the X-axis direction, the X-axis direction indicates both the X-axis positive direction and the X-axis negative direction, or one of the X-axis positive direction and the X-axis negative direction. The same applies to the Y-axis direction and the Z-axis direction. Hereinafter, in some cases, the X-axis direction is referred to as a predetermined direction. Expressions indicating a relative direction or posture, such as parallel and orthogonal, also include cases in which the direction or posture is not exactly the concerned direction or posture. A case where two directions are parallel (or orthogonal) means not only a case where the two directions are completely parallel (or orthogonal) but also a case where the two directions are substantially parallel (or orthogonal), that is, a case including, for example, a difference of several percent. In the following description, in a case where the term “insulation” is used, the term “insulation” means electrical insulation. A material having insulating properties is preferably formed from a material having a volume resistivity of 1×10¹⁰ Ωm or more.

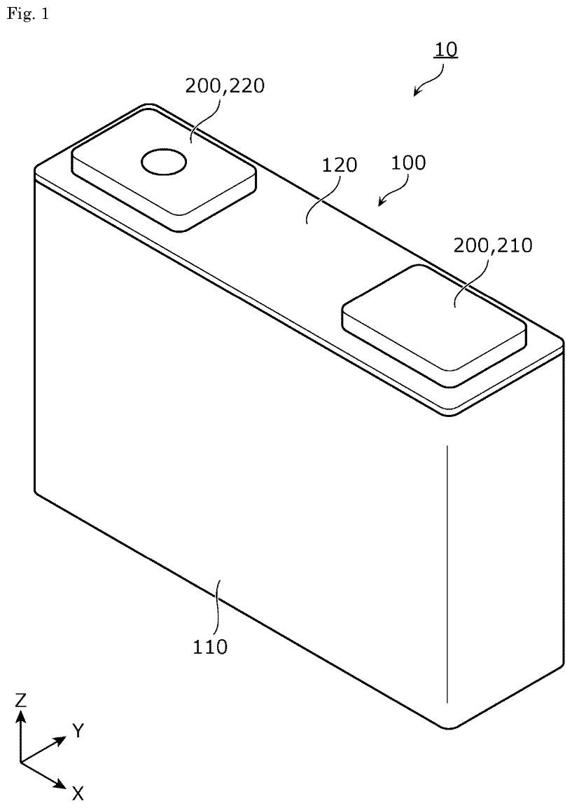

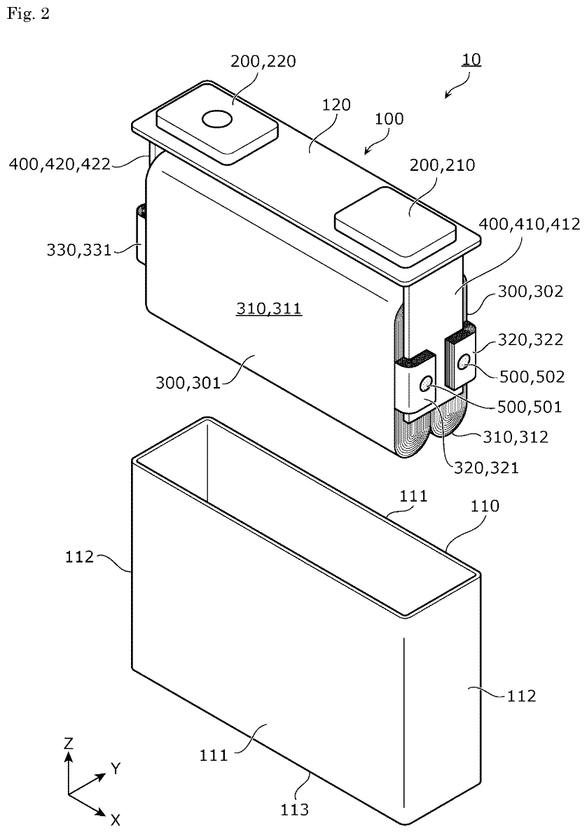

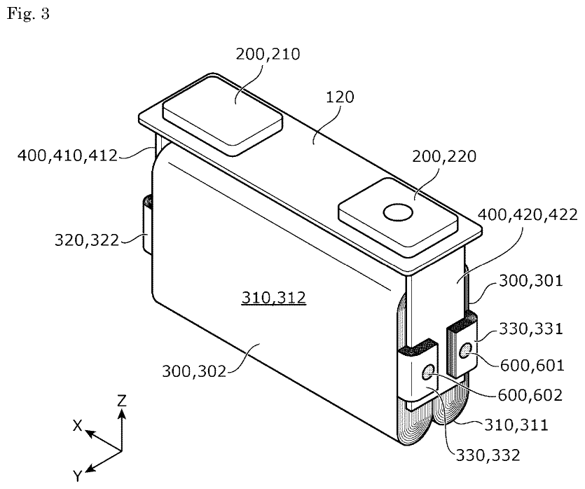

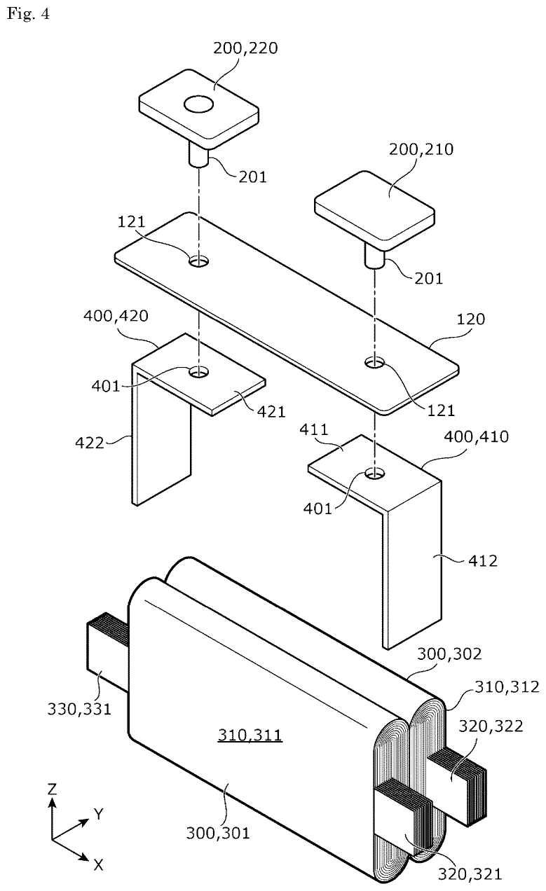

First, with reference to FIGS. 1 to 4, the configuration of an energy storage device 10 in the present example embodiment will be described in detail. FIG. 1 is a perspective view showing the appearance of the energy storage device 10 according to the present example embodiment. FIG. 2 is a perspective view showing an internal configuration of a case 100 of the energy storage device 10 according to the present example embodiment, with a case body 110 separated from the case 100. FIG. 3 is a perspective view showing an internal configuration of the case 100 in the energy storage device 10 according to the present example embodiment, as viewed from the side opposite to FIG. 2. FIG. 4 is an exploded perspective view showing, in an exploded manner, each element other than the case body 110 in the energy storage device 10 according to the present example embodiment.

The energy storage device 10 is a secondary battery (battery cell) that can be charged with electricity and can discharge electricity, and more specifically, is a nonaqueous electrolyte secondary battery such as a lithium ion secondary battery. The energy storage device 10 is used as a battery or the like for driving or engine starting of a moving body such as an automobile, a motorcycle, a watercraft, a ship, a snowmobile, an agricultural machine, a construction machine, an automatic guided vehicle (AGV), or a railway vehicle for electric railway. Examples of the automobile described above include electric vehicles (EVs), hybrid electric vehicles (HEVs), plug-in hybrid electric vehicles (PHEVs), and fossil fuel vehicles (gasoline vehicles, diesel vehicles, liquefied natural gas vehicles, and the like). Examples of the railway vehicle for electric railway described above include electric railcars, monorails, linear motor cars, and hybrid electric railcars including both a diesel engine and an electric motor. The energy storage device 10 can also be used as a stationary battery or the like used for home use or business use.

The energy storage device 10 is not limited to a nonaqueous electrolyte secondary battery and may be a secondary battery other than a nonaqueous electrolyte secondary battery or may be a capacitor. The energy storage device 10 may be a primary battery instead of a secondary battery. The energy storage device 10 may be a battery using a solid electrolyte. The energy storage device 10 may be a pouch-type energy storage device. In the present example embodiment, the energy storage device 10 having a rectangular parallelepiped shape (prismatic shape) flattened in the Y-axis direction is illustrated, but the shape of the energy storage device 10 is not limited to the rectangular parallelepiped shape and may be a polygonal prism shape other than the rectangular parallelepiped shape, an oblong cylindrical shape, an elliptical cylindrical shape, or a cylindrical shape.

As shown in FIG. 1, the energy storage device 10 includes the case 100 and a pair of terminals 200 (a positive electrode terminal and a negative electrode terminal). The energy storage device 10 further includes, as shown in FIGS. 2 to 4, an electrode assembly 300 and a pair of current collectors 400 (a positive electrode current collector and a negative electrode current collector), and accommodates the electrode assembly 300 and the pair of current collectors 400 inside the case 100. The energy storage device 10 also includes a pair of gaskets (a positive electrode gasket and a negative electrode gasket) arranged between the case 100 and the terminals 200 and between the case 100 and current collectors 400, but illustration of the pair of gaskets is omitted. An electrolyte solution (nonaqueous electrolyte) is sealed inside the case 100, but illustration of the electrolyte solution is omitted. The type of the electrolyte solution is not particularly limited as long as the electrolyte solution does not impair performance of the energy storage device 10, and various electrolyte solutions can be selected. The energy storage device 10 may further include, in addition to the above elements, a spacer arranged at a side of or below the electrode assembly 300 and an insulating film or the like wrapping the electrode assembly 300 and the like.

The case 100 is a rectangular parallelepiped-shaped (prismatic or box-shaped) case including the case body 110 in which an opening facing in the Z-axis positive direction is formed and a lid 120 that closes the opening of the case body 110.

The case body 110 is a member having a rectangular tubular shape and a bottom, constituting a main body portion of the case 100. The case body 110 includes a pair of long side wall portions 111 on surfaces on both sides in the Y-axis direction (long side surfaces), includes a pair of short side wall portions 112 on surfaces on both sides in the X-axis direction (short side surfaces), and includes a bottom wall portion 113 on a surface in the Z-axis negative direction (bottom surface) (see FIG. 2). Each long side wall portion 111 is a plate-shaped and rectangular wall portion extending in the X-axis direction. Each short side wall portion 112 is a plate-shaped and rectangular wall portion extending in the Z-axis direction. The bottom wall portion 113 is a plate-shaped and rectangular wall portion extending in the X-axis direction. The lid 120 is a member constituting a lid portion of the case 100 and is arranged in the Z-axis positive direction of the case body 110. The lid 120 is a plate-shaped and rectangular wall portion extending in the X-axis direction. Depending on the shape of the case 100, the long side wall portions 111 may be long in the Z-axis direction, the short side wall portions 112 may be long in the Y-axis direction, and the bottom wall portion 113 may be long in the Y-axis direction.

After the electrode assembly 300 and the like are accommodated in the case body 110, the interior of the case 100 is sealed (hermetically sealed) by joining the case body 110 and the lid 120 by welding or the like. The material of the case 100 (the case body 110 and the lid 120) is not particularly limited and can be a weldable (joinable) metal such as stainless steel, aluminum, an aluminum alloy, iron, or a plated steel sheet, and resin can also be used. The case body 110 and the lid 120 may be formed of the same material or may be formed of different materials. The case 100 (the lid 120) may be provided with a solution injecting portion for injecting an electrolyte solution into the inside of the case 100 during production of the energy storage device 10 and a gas release valve or the like for releasing the pressure when pressure inside the case 100 rises excessively.

Each terminal 200 is an electrode terminal (a positive electrode terminal and a negative electrode terminal) electrically connected to the electrode assembly 300 via the current collector 400. Each terminal 200 is a metal member for leading electricity stored in the electrode assembly 300 out to an external space of the energy storage device 10 and for leading electricity into an internal space of the energy storage device 10 to store electricity in the electrode assembly 300. Each terminal 200 is formed of a conductive member such as a metal including aluminum, an aluminum alloy, copper, or a copper alloy. Each terminal 200 is connected (joined) to the current collector 400 by caulking joining or welding or the like and is attached to the lid 120. Each terminal 200 is arranged in a state of protruding in the Z-axis positive direction from an outer surface of the lid 120 (a surface in the Z-axis positive direction). In the present example embodiment, each terminal 200 is a weld terminal joined by welding to a conductive member such as an external busbar, but each terminal 200 may be a bolt terminal including a bolt portion in which a male threaded portion projecting in the Z-axis positive direction is formed and joined to the conductive member by bolt joining.

In the present example embodiment, two terminals 200 (the positive electrode terminal 200 and the negative electrode terminal 200) are arranged side by side in the X-axis direction. Hereinafter, among the two terminals 200, one terminal 200 positioned in the X-axis positive direction is referred to as a first terminal 210, and the other terminal 200 positioned in the X-axis negative direction is referred to as a second terminal 220. In the present example embodiment, the first terminal 210 is the terminal 200 of the positive electrode (the positive electrode terminal), and the second terminal 220 is the terminal 200 of the negative electrode (the negative electrode terminal).

The electrode assembly 300 is an energy storage element (power generating element) that can store electricity, and is formed by stacking a positive electrode plate, a negative electrode plate, and a separator. The electrode assembly 300 is a wound-type electrode assembly formed by winding a positive electrode plate, a negative electrode plate, and a separator around a winding axis extending in the X-axis direction. The winding axis is a virtual axis serving as a central axis used at the time when the positive electrode plate, the negative electrode plate, and the like are wound, and, in the present example embodiment, is a straight line parallel to the X-axis direction and passing through a center of the electrode assembly 300. In the present example embodiment, the electrode assembly 300 has a long shape extending in the X-axis direction and has a substantially oblong cylindrical shape (an oblong shape as viewed in the X-axis direction). The shape of the electrode assembly 300 is not particularly limited and may be, for example, a substantially cylindrical shape or a substantially elliptic cylindrical shape, and the length of the electrode assembly 300 in the X-axis direction is also not particularly limited. For example, the electrode assembly 300 may be long in the Z-axis direction.

The positive electrode plate is a plate (electrode plate) in which a positive active material layer is formed on a surface of a positive electrode current collecting foil that is a long strip-shaped current collecting foil (metal foil) made of a metal such as aluminum or an aluminum alloy. The negative electrode plate is a plate (electrode plate) in which a negative active material layer is formed on a surface of a negative electrode current collecting foil that is a long strip-shaped current collecting foil (metal foil) made of a metal such as copper or a copper alloy. As the positive electrode current collecting foil and the negative electrode current collecting foil, a known material can be appropriately used as long as the material is stable against an oxidation-reduction reaction during charge and discharge, the material including nickel, iron, stainless steel, titanium, furnace carbon, a conductive polymer, conductive glass, or an Al—Cd alloy. As the positive active material used for the positive active material layer and the negative active material used for the negative active material layer, a known material can be appropriately used as long as the positive active material and the negative active material can occlude and release charge transport ions.

As the positive active material, it is possible to use a polyanion compound such as LiMPO₄, LiMSiO₄, or LiMBO₃ (M is one or more transition metal elements selected from Fe, Ni, Mn, Co, and the like), lithium titanate, a spinel-type lithium manganese oxide such as LiMn₂O₄ or LiMn_{1.5}Ni_{0.5}O₄, or a lithium transition metal oxide such as LiMO₂ (M is one or more transition metal elements selected from Fe, Ni, Mn, Co, and the like). Examples of the negative active material include lithium metal, lithium alloys (lithium-metal-containing alloys such as lithium-silicon, lithium-aluminum, lithium-lead, lithium-tin, lithium-aluminum-tin, lithium-gallium, and Wood's alloy), alloys that can occlude and release lithium, carbon materials (graphite, hard carbon, soft carbon, low-temperature calcined carbon, amorphous carbon, and the like), silicon oxide, metal oxide, lithium metal oxides (Li₄Ti₅O₁₂ and the like), polyphosphate compounds, or compounds of a transition metal and a group 14 to group 16 element, such as Co₃O₄ or Fe₂P and generally called conversion negative electrodes.

The separator is a microporous insulating sheet made of resin or the like. As a material of the separator, a known material can be appropriately used as long as the material does not impair performance of the energy storage device 10. Examples of the separator include a woven fabric, a nonwoven fabric, and a porous resin film.

Hereinafter, among the positive electrode plate and the negative electrode plate, one is referred to as a first plate 320 and the other is referred to as a second plate 330. That is, the first plate 320 and the second plate 330 are one and the other of the positive electrode plate and the negative electrode plate. In the present example embodiment, the first plate 320 is the positive electrode plate, and the second plate 330 is the negative electrode plate. The first plate 320 includes a plurality of tabs (positive electrode tabs) projecting in the X-axis positive direction, and by the first plate 320 being wound, the plurality of tabs (positive electrode tabs), which is part of the first plate 320, is brought into an overlapping state. The second plate 330 includes a plurality of tabs (negative electrode tabs) projecting in the X-axis negative direction, and by the second plate 330 being wound, the plurality of tabs (negative electrode tabs), which is part of the second plate 330, is brought into an overlapping state. As a result, the electrode assembly 300 has a configuration including an electrode assembly body portion 310, a part of the first plate 320 (the plurality of tabs) projecting in the X-axis positive direction from the electrode assembly body portion 310, and a part of the second plate 330 (the plurality of tabs) projecting in the X-axis negative direction from the electrode assembly body portion 310. In other words, the plurality of tabs (positive electrode tabs) extends (projects) outward from a part of an end edge of the electrode assembly body portion 310, and the plurality of tabs (negative electrode tabs) extends (projects) outward from a part of the end edge of the electrode assembly body portion 310. The electrode assembly body portion 310 is a portion constituting a main body of the electrode assembly 300 and is an oblong cylindrical portion formed by winding the portions other than the tabs of the positive electrode plate and the negative electrode plate together with the separator.

In the present example embodiment, the energy storage device 10 includes two electrode assemblies 300 (an electrode assembly 301 and an electrode assembly 302). The electrode assembly 301 and the electrode assembly 302 are both wound-type electrode assemblies formed by winding a positive electrode plate, a negative electrode plate, and a separator. For this reason, the electrode assembly 301 has a configuration including an electrode assembly body portion 311, a part of the first plate 320 (the plurality of tabs) projecting in the X-axis positive direction from the electrode assembly body portion 311, and a part of the second plate 330 (the plurality of tabs) projecting in the X-axis negative direction from the electrode assembly body portion 311. Here, a portion of the electrode assembly 301 in which the plurality of tabs that is part of the first plate 320 are bundled is referred to as a first tab portion 321. A portion of the electrode assembly 301 in which the plurality of tabs that is part of the second plate 330 are bundled is referred to as a second tab portion 331. That is, the electrode assembly 301 has a configuration including the electrode assembly body portion 311, the first tab portion 321 projecting in the X-axis positive direction from the electrode assembly body portion 311, and the second tab portion 331 projecting in the X-axis negative direction from the electrode assembly body portion 311. In the present example embodiment, the first tab portion 321 is a positive electrode tab portion (a positive electrode tab bundle) in which the plurality of positive electrode tabs of the electrode assembly 301 is bundled, and the second tab portion 331 is a negative electrode tab portion (a negative electrode tab bundle) in which the plurality of negative electrode tabs of the electrode assembly 301 is bundled.

Similarly, the electrode assembly 302 includes an electrode assembly body portion 312, a part of the first plate 320 (the plurality of tabs) projecting in the X-axis positive direction from the electrode assembly body portion 312, and a part of the second plate 330 (the plurality of tabs) projecting in the X-axis negative direction from the electrode assembly body portion 312. A portion of the electrode assembly 302 in which the plurality of tabs that is part of the first plate 320 are bundled is referred to as a first tab portion 322. A portion of the electrode assembly 302 in which the plurality of tabs that is part of the second plate 330 are bundled is referred to as a second tab portion 332. That is, the electrode assembly 302 has a configuration including the electrode assembly body portion 312, the first tab portion 322 projecting in the X-axis positive direction from the electrode assembly body portion 312, and the second tab portion 332 projecting in the X-axis negative direction from the electrode assembly body portion 312. In the present example embodiment, the first tab portion 322 is a positive electrode tab portion (a positive electrode tab bundle) in which the plurality of positive electrode tabs of the electrode assembly 302 is bundled, and the second tab portion 332 is a negative electrode tab portion (a negative electrode tab bundle) in which the plurality of negative electrode tabs of the electrode assembly 302 is bundled.

The first plate 320 (the first tab portions 321 and 322) is connected (joined) to a first current collector 410 described later, and the second plate 330 (the second tab portions 331 and 332) is connected (joined) to a second current collector 420 described later.

The current collector 400 is a conductive current collecting member (a positive electrode current collector and a negative electrode current collector) arranged on both sides of the electrode assembly 300 in the X-axis direction and connected (joined) to the electrode assembly 300 and the terminal 200 to electrically connect the electrode assembly 300 and the terminal 200. The current collector 400 has a shape in which one plate-shaped member is bent, and is an L-shaped (inverted L-shaped) member as viewed in the Y-axis direction. The current collector 400 has a simple configuration and therefore can be easily produced. Because the current collector 400 can be formed of one plate-shaped member, the number of parts can be reduced without a need to separately provide a lead or the like, and the capacity of the energy storage device 10 can also be improved by reducing the space occupied by the current collector 400 (by saving space).

In the present example embodiment, two current collectors 400 (the positive electrode current collector 400 and the negative electrode current collector 400) are arranged side by side in the X-axis direction. Hereinafter, among the two current collectors 400, one current collector 400 positioned in the X-axis positive direction is referred to as the first current collector 410, and the other current collector 400 positioned in the X-axis negative direction is referred to as the second current collector 420. In the present example embodiment, the first current collector 410 is the current collector 400 of the positive electrode (the positive electrode current collector), and the second current collector 420 is the current collector 400 of the negative electrode (the negative electrode current collector). The first current collector 410 (the positive electrode current collector) is formed of aluminum or an aluminum alloy or the like, similarly to the current collecting foil (the positive electrode current collecting foil) of the first plate 320 of the electrode assembly 300. The second current collector 420 (the negative electrode current collector) is formed of copper or a copper alloy or the like, similarly to the current collecting foil (the negative electrode current collecting foil) of the second plate 330 of the electrode assembly 300.

As shown in FIG. 4, the first current collector 410 includes a first terminal connection portion 411 and a first electrode assembly connection portion 412. The first terminal connection portion 411 is a plate-shaped and rectangular portion parallel to the XY plane and is connected (joined) to the terminal 200 (the first terminal 210). The first terminal connection portion 411 is arranged along the lid 120 and includes a through hole 401 through which a shaft portion 201 included in the first terminal 210 passes. The shaft portion 201 is a rivet portion of the first terminal 210 extending in the Z-axis negative direction. The shaft portion 201 is inserted into a through hole 121 of the lid 120 and the through hole 401 of the first terminal connection portion 411 and is caulked. As a result, the first current collector 410 is fixed to the lid 120 together with the first terminal 210. A technique for connecting (joining) the first current collector 410 and the first terminal 210 is not limited to caulking joining, and ultrasonic bonding, welding such as laser welding or resistance welding, mechanical joining other than caulking, such as screw joining, or the like, may be used.

The first electrode assembly connection portion 412 is a plate-shaped and rectangular portion parallel to the YZ plane and is connected (joined) to the electrode assembly 300. The first electrode assembly connection portion 412 extends in the Z-axis negative direction from an end portion of the first terminal connection portion 411 in the X-axis positive direction along the short side wall portion 112 of the case body 110 in the X-axis positive direction. The first electrode assembly connection portion 412 is connected (joined) to the first plate 320 of the electrode assembly 300. Specifically, the first electrode assembly connection portion 412 is connected (joined) to the first tab portion 321 of the first plate 320 of the electrode assembly 301 and the first tab portion 322 of the first plate 320 of the electrode assembly 302.

In the present example embodiment, the first electrode assembly connection portion 412 is joined to the first tab portions 321 and 322 of the first plate 320 by resistance welding or ultrasonic bonding. As a result, as shown in FIG. 2, a first joint portion 500 is formed in the first electrode assembly connection portion 412 and the first tab portions 321 and 322. Specifically, a first joint portion 501 is formed in the first electrode assembly connection portion 412 and the first tab portion 321, and a first joint portion 502 is formed in the first electrode assembly connection portion 412 and the first tab portion 322. The first joint portion 500 (501, 502) is a joint portion (a joining mark, a resistance welding mark, or an ultrasonic bonding mark) formed by resistance welding or ultrasonic bonding. In this way, the first joint portion 500 joined by resistance welding or ultrasonic bonding is formed in the first plate 320 and the first current collector 410.

Specifically, the first plate 320 is arranged on an outside of the first current collector 410 and is joined to the first current collector 410 in a state of being bent toward the first current collector 410. That is, the first tab portion 321 is arranged in the X-axis positive direction of the first electrode assembly connection portion 412 and is joined to the first electrode assembly connection portion 412 in a state of being bent in the Y-axis positive direction toward the first electrode assembly connection portion 412, and the first joint portion 501 is formed. The first tab portion 322 is arranged in the X-axis positive direction of the first electrode assembly connection portion 412 and is joined to the first electrode assembly connection portion 412 in a state of being bent in the Y-axis negative direction toward the first electrode assembly connection portion 412, and the first joint portion 502 is formed. In this way, the first plate 320 (the first tab portions 321 and 322) is joined to an outside of the first current collector 410 (the first electrode assembly connection portion 412) in a state of wrapping around the first current collector 410 from both sides in the Y-axis direction of the first current collector 410 (the first electrode assembly connection portion 412). As a result, the first joint portion 500 (501, 502) is formed at one end portion (an end portion in the X-axis positive direction) of the electrode assembly 300 (301, 302) in the predetermined direction (the X-axis direction).

Similarly to the first current collector 410, the second current collector 420 includes a second terminal connection portion 421 and a second electrode assembly connection portion 422. The second terminal connection portion 421 is a plate-shaped and rectangular portion parallel to the XY plane and is connected (joined) to the terminal 200 (the second terminal 220). The second terminal connection portion 421 is arranged along the lid 120 and includes a through hole 401 through which the shaft portion 201 included in the second terminal 220 passes. Because a configuration in which the second terminal connection portion 421 is joined to the second terminal 220 is the same as a configuration in which the first terminal connection portion 411 is joined to the first terminal 210, detailed description is omitted.

The second electrode assembly connection portion 422 is a plate-shaped and rectangular portion parallel to the YZ plane and is connected (joined) to the electrode assembly 300. The second electrode assembly connection portion 422 extends in the Z-axis negative direction from an end portion of the second terminal connection portion 421 in the X-axis negative direction along the short side wall portion 112 of the case body 110 in the X-axis negative direction. The second electrode assembly connection portion 422 is connected (joined) to the second plate 330 of the electrode assembly 300. Specifically, the second electrode assembly connection portion 422 is connected (joined) to the second tab portion 331 of the second plate 330 of the electrode assembly 301 and the second tab portion 332 of the second plate 330 of the electrode assembly 302.

In the present example embodiment, the second electrode assembly connection portion 422 is joined to the second tab portions 331 and 332 of the second plate 330 by laser welding. As a result, as shown in FIG. 3, a second joint portion 600 is formed in the second electrode assembly connection portion 422 and the second tab portions 331 and 332. Specifically, a second joint portion 601 is formed in the second electrode assembly connection portion 422 and the second tab portion 331, and a second joint portion 602 is formed in the second electrode assembly connection portion 422 and the second tab portion 332. The second joint portion 600 (601, 602) is a joint portion (a joining mark or a laser welding mark) formed by laser welding. In this way, the second joint portion 600 joined by laser welding is formed in the second plate 330 and the second current collector 420.

Specifically, the second plate 330 is arranged on an outside of the second current collector 420 and is joined to the second current collector 420 in a state of being bent toward the second current collector 420. That is, the second tab portion 331 is arranged in the X-axis negative direction of the second electrode assembly connection portion 422 and is joined to the second electrode assembly connection portion 422 in a state of being bent in the Y-axis positive direction toward the second electrode assembly connection portion 422, and the second joint portion 601 is formed. The second tab portion 332 is arranged in the X-axis negative direction of the second electrode assembly connection portion 422 and is joined to the second electrode assembly connection portion 422 in a state of being bent in the Y-axis negative direction toward the second electrode assembly connection portion 422, and the second joint portion 602 is formed. In this way, the second plate 330 (the second tab portions 331 and 332) is joined to an outside of the second current collector 420 (the second electrode assembly connection portion 422) in a state of wrapping around the second current collector 420 from both sides in the Y-axis direction of the second current collector 420 (the second electrode assembly connection portion 422). As a result, the second joint portion 600 (601, 602) is formed at the other end portion (an end portion in the X-axis negative direction) of the electrode assembly 300 (301, 302) in the predetermined direction (the X-axis direction).

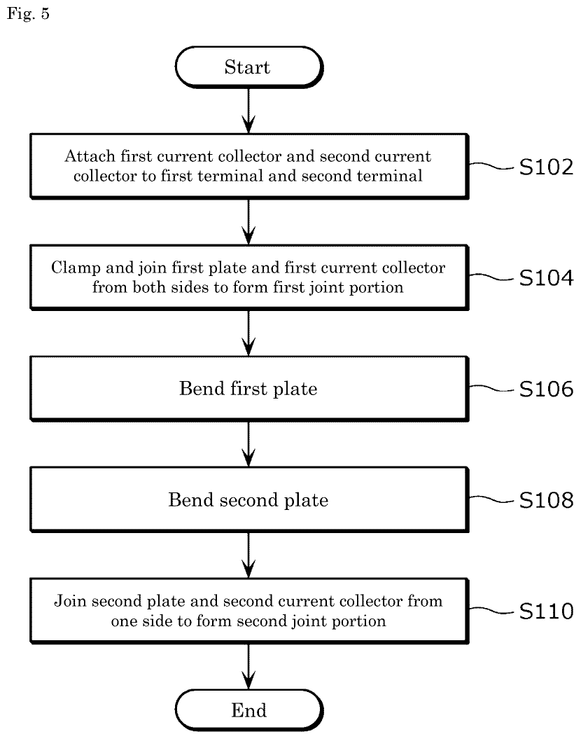

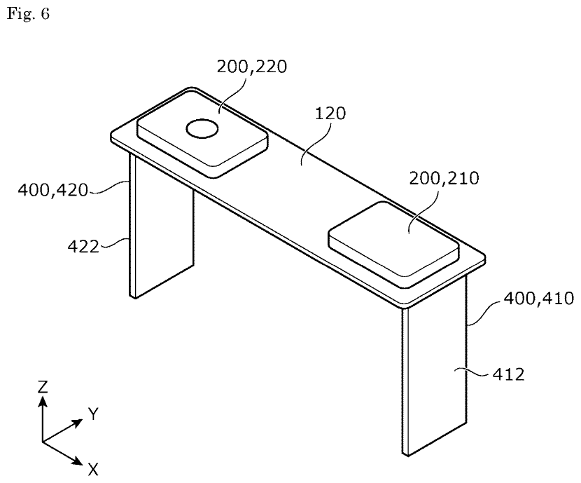

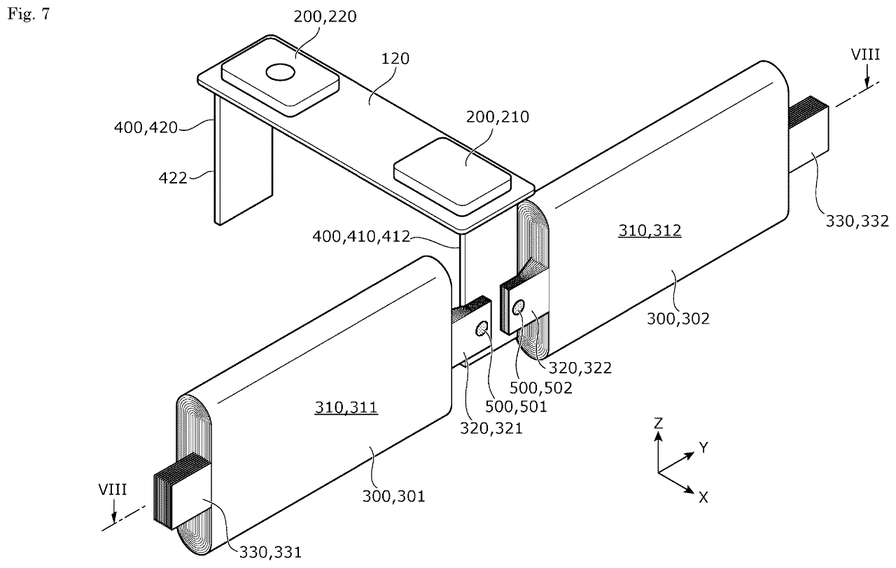

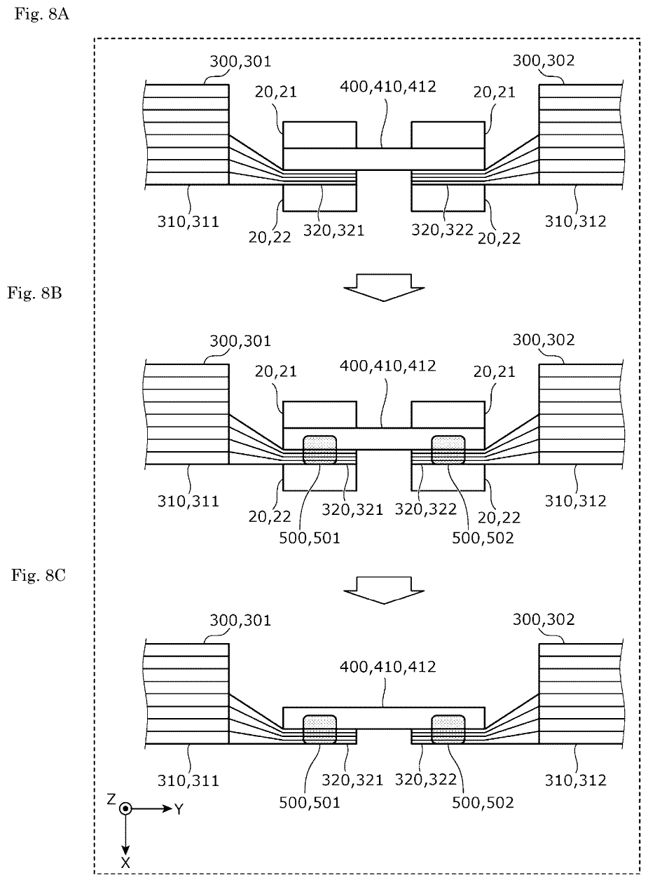

Next, with reference to FIGS. 5 to 10, the method for producing the energy storage device 10 in the present example embodiment will be described in detail. FIG. 5 is a flowchart showing producing steps in the method for producing the energy storage device 10 according to the present example embodiment. FIG. 6 is a perspective view showing a step of attaching the current collector 400 to the terminal 200 in the method for producing the energy storage device 10 according to the present example embodiment. FIG. 6 shows a state after the first current collector 410 is attached to the first terminal 210 and the second current collector 420 is attached to the second terminal 220. FIG. 7 is a perspective view showing a step of forming the first joint portion 500 in the method for producing the energy storage device 10 according to the present example embodiment. FIG. 7 shows a state after the first plate 320 (the first tab portions 321 and 322) and the first current collector 410 (the first electrode assembly connection portion 412) are joined and the first joint portion 500 (501, 502) is formed. FIGS. 8A to 8C are cross-sectional views showing a step of forming the first joint portion 500 in the method for producing the energy storage device 10 according to the present example embodiment. FIGS. 8A to 8C show a process of forming the first joint portion 500 (501, 502) by clamping and joining the first plate 320 (the first tab portions 321 and 322) and the first current collector 410 (the first electrode assembly connection portion 412) from both sides. FIGS. 8A to 8C show a cross section in a case where the configuration shown in FIG. 7 is cut along a plane parallel to the XY plane and including a line VIII-VIII.

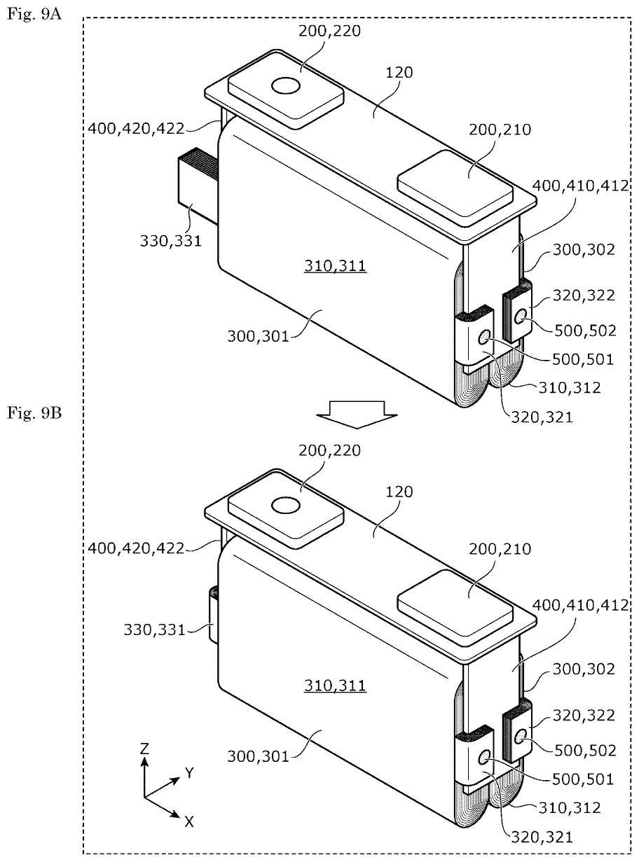

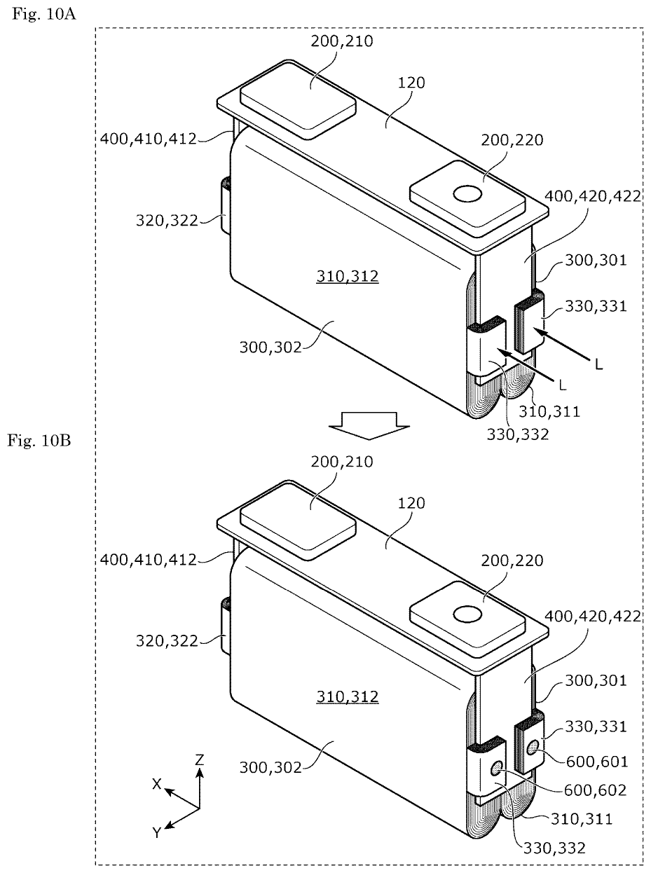

FIGS. 9A and 9B are perspective views showing a step of bending the first plate 320 and a step of bending the second plate 330 in the method for producing the energy storage device 10 according to the present example embodiment. FIG. 9A shows a state after the first plate 320 (the first tab portions 321 and 322) is bent. FIG. 9B shows a state after the second plate 330 (the second tab portions 331 and 332) is bent. FIGS. 10A and 10B are perspective views showing a step of forming the second joint portion 600 in the method for producing the energy storage device 10 according to the present example embodiment. FIG. 10A shows a process of joining the second plate 330 (the second tab portions 331 and 332) and the second current collector 420 (the second electrode assembly connection portion 422). FIG. 10B shows a state after the second plate 330 (the second tab portions 331 and 332) and the second current collector 420 (the second electrode assembly connection portion 422) are joined and the second joint portion 600 (601, 602) is formed.

As shown in FIG. 5, first, the first current collector 410 and the second current collector 420 are attached to the first terminal 210 and the second terminal 220 (S102: current collector attachment step).

Specifically, as shown in FIG. 6, the first current collector 410 is attached to the first terminal 210, and the second current collector 420 is attached to the second terminal 220. As described above, the first current collector 410 is joined to the first terminal 210 by caulking joining or the like, and the second current collector 420 is joined to the second terminal 220 by caulking joining or the like, so that the first current collector 410 and the second current collector 420 are fixed to the lid 120 together with the first terminal 210 and the second terminal 220.

Returning to FIG. 5, next, the first joint portion 500 is formed by clamping and joining the first plate 320 and the first current collector 410 from both sides (S104: first joint portion forming step). As described above, because the first plate 320 is the positive electrode plate and the first current collector 410 is the positive electrode current collector, in the forming of the first joint portion 500 (S104), the positive electrode plate and the positive electrode current collector are clamped and joined from both sides to form the first joint portion 500.

Specifically, as shown in FIG. 7, the electrode assembly 301 and the electrode assembly 302 are arranged on both sides of the first current collector 410 in the Y-axis direction in a posture extending along the Y-axis direction. Then, the first plate 320 of the electrode assembly 301 and the first plate 320 of the electrode assembly 302 are joined to the first current collector 410 to form the first joint portion 500. That is, the first tab portion 321 of the first plate 320 of the electrode assembly 301 is arranged outside the first electrode assembly connection portion 412 of the first current collector 410 (in the X-axis positive direction), and the first tab portion 321 and the first electrode assembly connection portion 412 are joined to form the first joint portion 501. The first tab portion 322 of the first plate 320 of the electrode assembly 302 is arranged outside the first electrode assembly connection portion 412 of the first current collector 410 (in the X-axis positive direction), and the first tab portion 322 and the first electrode assembly connection portion 412 are joined to form the first joint portion 502.

More specifically, as shown in FIG. 8A, the first tab portion 321 of the first plate 320 of the electrode assembly 301 is arranged in the X-axis positive direction of an end portion in the Y-axis negative direction of the first electrode assembly connection portion 412 of the first current collector 410 and is clamped from both sides in the X-axis direction by a joining apparatus 20 (21 and 22). Similarly, the first tab portion 322 of the first plate 320 of the electrode assembly 302 is arranged in the X-axis positive direction of an end portion in the Y-axis positive direction of the first electrode assembly connection portion 412 of the first current collector 410 and is clamped from both sides in the X-axis direction by the joining apparatus 20 (21 and 22). The joining apparatus 20 (21 and 22) is a device that joins two members by clamping the two members from both sides. In the present example embodiment, the joining apparatus 20 (21 and 22) is an apparatus (an anvil and a horn) that performs ultrasonic bonding (solid-phase joining), but may be an apparatus (two electrodes) that performs resistance welding (fusion joining).

Then, as shown in FIG. 8B, the first tab portions 321 and 322 and the first electrode assembly connection portion 412 are joined by the joining apparatus 20 (21 and 22). That is, the first tab portion 321 and the first electrode assembly connection portion 412 are joined by resistance welding or ultrasonic bonding to form the first joint portion 501. The first tab portion 322 and the first electrode assembly connection portion 412 are joined by resistance welding or ultrasonic bonding to form the first joint portion 502. Then, as shown in FIG. 8C, a state in which the joining apparatus 20 (21 and 22) clamps the first tab portions 321 and 322 and the first electrode assembly connection portion 412 is released, and the joining apparatus 20 (21 and 22) is removed. On both surfaces in the X-axis direction of the first plate 320 (the first tab portions 321 and 322) and the first current collector 410 (the first electrode assembly connection portion 412), traces of the joining performed by clamping with the joining apparatus 20 (21 and 22) (joining marks, welding marks, dents formed at the time of pressing, and the like) are formed.

Returning to FIG. 5, next, the first plate 320 is bent (S106: first plate bending step). That is, the first plate 320 is bent after the forming of the first joint portion 500 (S104).

Specifically, the first plate 320 (the first tab portions 321 and 322) is bent so that the state shown in FIG. 7 becomes the state shown in FIG. 9A. With respect to the electrode assembly 301, the first tab portion 321 is bent such that the electrode assembly 301, which has been arranged in a posture extending in the Y-axis negative direction from the first current collector 410, is arranged in a posture extending in the X-axis negative direction from the first current collector 410. That is, by rotating the electrode assembly body portion 311 toward the X-axis negative direction while bending the first tab portion 321 about the vicinity of the first joint portion 501 as a center, the electrode assembly body portion 311 is arranged in the Z-axis negative direction of the lid 120 (between the first current collector 410 and the second current collector 420). With respect to the electrode assembly 302, the first tab portion 322 is bent such that the electrode assembly 302, which has been arranged in a posture extending in the Y-axis positive direction from the first current collector 410, is arranged in a posture extending in the X-axis negative direction from the first current collector 410. That is, by rotating the electrode assembly body portion 312 toward the X-axis negative direction while bending the first tab portion 322 about the vicinity of the first joint portion 502 as a center, the electrode assembly body portion 312 is arranged in the Z-axis negative direction of the lid 120 (between the first current collector 410 and the second current collector 420). As a result, the electrode assembly 301 and the electrode assembly 302 are arranged side by side in the Y-axis direction.

Returning to FIG. 5, next, the second plate 330 is bent (S108: second plate bending step). That is, the second plate 330 is bent after the bending of the first plate 320 (S106).

Specifically, as shown in FIG. 9B (and FIG. 10A), the second plate 330 (the second tab portions 331 and 332) is bent such that front end portions of the second plate 330 (the second tab portions 331 and 332) are arranged outside the second current collector 420 (in the X-axis negative direction). With respect to the electrode assembly 301, a front end portion of the second tab portion 331 is bent in the Y-axis positive direction such that the front end portion of the second tab portion 331 is arranged outside the second electrode assembly connection portion 422 of the second current collector 420 (in the X-axis negative direction), and the front end portion of the second tab portion 331 and the second electrode assembly connection portion 422 are superposed. With respect to the electrode assembly 302, a front end portion of the second tab portion 332 is bent in the Y-axis negative direction such that the front end portion of the second tab portion 332 is arranged outside the second electrode assembly connection portion 422 of the second current collector 420 (in the X-axis negative direction), and the front end portion of the second tab portion 332 and the second electrode assembly connection portion 422 are superposed.

Returning to FIG. 5, next, the second plate 330 and the second current collector 420 are joined from one side, and the second joint portion 600 is formed (S110: second joint portion forming step). That is, the forming of the second joint portion 600 (S110) is performed after the forming of the first joint portion 500 (S104), after the bending of the first plate 320 (S106), and after the bending of the second plate 330 (S108). As described above, because the second plate 330 is the negative electrode plate and the second current collector 420 is the negative electrode current collector, in the forming of the second joint portion 600 (S110), the negative electrode plate and the negative electrode current collector are joined from one side to form the second joint portion 600.

Specifically, as shown in FIG. 10A, a laser beam L is irradiated toward the second plate 330 and the second current collector 420 from one side of the second plate 330 and the second current collector 420 (from the X-axis negative direction side). That is, the laser beam L is irradiated toward the second tab portion 331 and the second electrode assembly connection portion 422 from one side of the second tab portion 331 of the second plate 330 of the electrode assembly 301 and the second electrode assembly connection portion 422 of the second current collector 420 (from the outside, the X-axis negative direction). The laser beam L is irradiated toward the second tab portion 332 and the second electrode assembly connection portion 422 from one side (the outside, the X-axis negative direction) of the second tab portion 332 of the second plate 330 of the electrode assembly 302 and the second electrode assembly connection portion 422 of the second current collector 420.

As a result, as shown in FIG. 10B, the second tab portion 331 and the second electrode assembly connection portion 422 are joined by laser welding (fusion joining), and the second joint portion 601 is formed. The second tab portion 332 and the second electrode assembly connection portion 422 are joined by laser welding (fusion joining), and the second joint portion 602 is formed. On one-side surface (surfaces of the second tab portions 331 and 332 in the X-axis negative direction) of the second plate 330 (the second tab portions 331 and 332) and the second current collector 420 (the second electrode assembly connection portion 422), traces of the joining performed from one side (joining marks and welding marks) are formed. In a case where the second plate 330 (the second tab portions 331 and 332) and the second current collector 420 (the second electrode assembly connection portion 422) are through-welded by laser welding, a joining mark (a welding mark) is also formed on a surface of the second electrode assembly connection portion 422 in the X-axis positive direction.

In this way, the first joint portion 500 and the second joint portion 600 are formed at both end portions of the electrode assembly 300 in the predetermined direction (the X-axis direction). That is, in the forming of the first joint portion 500 (S104 in FIG. 5), the first joint portion 500 is formed at one end portion (an end portion in the X-axis positive direction) of the electrode assembly 300 in the predetermined direction (the X-axis direction). In the forming of the second joint portion 600 (S110 in FIG. 5), after the forming of the first joint portion 500 (S104 in FIG. 5), the second joint portion 600 is formed at the other end portion (an end portion in the X-axis negative direction) of the electrode assembly 300 in the predetermined direction (the X-axis direction).

As described above, according to the method for producing the energy storage device 10 according to the example embodiment of the present invention, the method includes: forming the first joint portion 500 by clamping and joining the first plate 320 and the first current collector 410 from both sides, and forming the second joint portion 600 by joining the second plate 330 and the second current collector 420 from one side. In this way, the first joint portion 500 and the second joint portion 600 are formed by different joining methods, namely, the first joint portion 500 is formed by clamping and joining the first plate 320 and the first current collector 410 from both sides, and the second joint portion 600 is formed by joining the second plate 330 and the second current collector 420 from one side. As a result, during the joining operation, the electrode assembly 300 and the current collector 400 can be joined by selecting a joining method suitable for the state and the like of a joining location, and therefore, flexibility in the joining operation between the electrode assembly 300 and the current collector 400 can be improved.

In the method for producing the energy storage device 10, after the first joint portion 500 is formed at one end portion of the electrode assembly 300, the second joint portion 600 is formed at the other end portion of the electrode assembly 300. Here, in the forming of the first joint portion 500, because the first plate 320 and the first current collector 410 are clamped and joined from both sides, during the joining operation, it is necessary to secure spaces on both sides of the first plate 320 and the first current collector 410. In the forming of the second joint portion 600, because the second plate 330 and the second current collector 420 are joined from one side, during the joining operation, it is sufficient to secure a space on one side of the second plate 330 and the second current collector 420. In a configuration in which joint portions are formed at both end portions of the electrode assembly 300, a space is more easily secured on a side for which the joining operation is performed first. Therefore, the second joint portion 600 is formed after the first joint portion 500 is formed. In other words, the first joint portion 500 is formed before the second joint portion 600 is formed. As a result, in the forming of the first joint portion 500, the joining operation can be performed in a state in which spaces are secured on both sides of the first plate 320 and the first current collector 410. Therefore, flexibility in the joining operation between the electrode assembly 300 and the current collector 400 can be further improved.

In the method for producing the energy storage device 10, bending of the first plate 320 is performed after the forming of the first joint portion 500, and the second joint portion 600 is formed after the bending of the first plate 320. In this way, by bending the first plate 320 after the first joint portion 500 is formed, the second plate 330 can be brought close to the second current collector 420 in the forming of the second joint portion 600. As a result, the joining operation of the second plate 330 and the second current collector 420 can be facilitated, and therefore, the second joint portion 600 can be formed easily. Therefore, flexibility in the joining operation between the electrode assembly 300 and the current collector 400 can be further improved.

In the method for producing the energy storage device 10, the second joint portion 600 is formed after the bending of the second plate 330 is performed. In this way, by performing the bending of the second plate 330, the second plate 330 can easily be brought close to the second current collector 420 in the forming of the second joint portion 600. As a result, the joining operation of the second plate 330 and the second current collector 420 can be further facilitated, and therefore, the second joint portion 600 can be formed more easily.

In the method for producing the energy storage device 10, the first joint portion 500 is formed by clamping and joining the positive electrode plate and the positive electrode current collector from both sides, and the second joint portion 600 is formed by joining the negative electrode plate and the negative electrode current collector from one side. Here, at the time when the joining operation is performed while the device is reached from one side, a large load is difficult to be applied, and therefore, joining by melting the vicinity of the interface is often used, but in this case, there is a risk that a joining defect such as a crack occurs in a joint portion (a melted portion of stacked foils). The risk varies depending on the coefficient of expansion, strength, and the like of the material, and there is a possibility that the risk becomes more pronounced in a case where the positive electrode plate (an aluminum material) is joined. Accordingly, by clamping and joining the positive electrode plate and the positive electrode current collector from both sides, the risk can be reduced while flexibility in the joining operation between the electrode assembly 300 and the current collector 400 can be further improved.

The electrode assembly 300 includes tab portions (the first tab portions 321 and 322 and the second tab portions 331 and 332), and the tab portions are joined to the current collector 400 (the first current collector 410 and the second current collector 420). Therefore, at the time when the tab portions are joined to the current collector 400, the tab portions can be bent and joined to the current collector 400, and therefore, the tab portions can be easily joined to the current collector 400.

The second plate 330 (the second tab portions 331 and 332) is arranged outside the second current collector 420 (the second electrode assembly connection portion 422) (in the X-axis negative direction) and is joined thereto. Therefore, at the time when laser welding is performed, the second tab portions 331 and 332 can be easily pressed toward the second electrode assembly connection portion 422. When the second tab portions 331 and 332 are arranged inside the second electrode assembly connection portion 422 (in the X-axis positive direction), it becomes necessary to increase output of the laser beam L, and the second tab portions 331 and 332 are easily damaged. Therefore, by arranging the second tab portions 331 and 332 outside the second electrode assembly connection portion 422 (in the X-axis negative direction), output of the laser beam L can be lowered, and therefore, damage to the second tab portions 331 and 332 can be suppressed.

According to the energy storage device 10 according to the example embodiment of the present invention, the first plate 320 and the first current collector 410 are provided with the first joint portion 500 joined by resistance welding or ultrasonic bonding, and the second plate 330 and the second current collector 420 are provided with the second joint portion 600 joined by laser welding. In this way, the first joint portion 500 and the second joint portion 600 are formed by different joining methods. As a result, during the joining operation, the electrode assembly 300 and the current collector 400 can be joined by selecting a joining method suitable for the state and the like of a joining location, and therefore, flexibility in the joining operation between the electrode assembly 300 and the current collector 400 can be improved.

The method for producing the energy storage device 10 and the energy storage device 10 according to the example embodiment of the present invention has been described above, but the present invention is not limited to the above example embodiment. The example embodiment disclosed this time is illustrative in all respects, and the scope of the present invention includes all modifications within the meaning and scope equivalent to the claims.

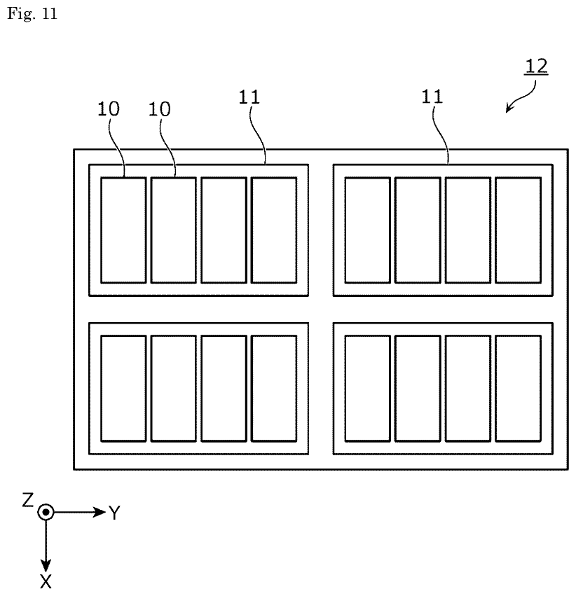

The energy storage device 10 may be used in an energy storage apparatus. In this case, the technology of the present invention only needs to be applied to at least one energy storage device 10 included in the energy storage apparatus. FIG. 11 is a plan view showing one example of an energy storage apparatus 12 according to a modification example of the present example embodiment. As shown in FIG. 11, a plurality of energy storage units 11 is arranged inside the energy storage apparatus 12. The energy storage unit 11 is configured with a plurality of electrically connected energy storage devices 10. The energy storage apparatus 12 may include a busbar (not illustrated) electrically connecting the plurality of energy storage devices 10, a busbar (not illustrated) electrically connecting the plurality of energy storage units 11, and the like. The energy storage unit 11 or the energy storage apparatus 12 may include a state monitoring apparatus (not illustrated) that monitors a state of one or more energy storage devices 10. The energy storage apparatus 12 may include only one energy storage unit 11. That is, the energy storage unit 11 may be referred to as an energy storage apparatus.

In the above example embodiment, the first plate 320 of the electrode assembly 300 includes the tab portions (the first tab portions 321 and 322), and the tab portions are joined to the first current collector 410, but the first plate 320 may not include a tab portion. In this case, an end portion of the electrode assembly 300 in the X-axis positive direction (a portion projecting (outward) in the X-axis positive direction from the entirety of an end edge of the electrode assembly body portion 310) may be joined to the first current collector 410. The same applies to the tab portions (the second tab portions 331 and 332) of the second plate 330.

In the above example embodiment, the first plate 320 (the first tab portions 321 and 322) is arranged and joined on the outside (in the X-axis positive direction) of the first current collector 410 (the first electrode assembly connection portion 412), but may be arranged in the inside (in the X-axis negative direction) thereof. Similarly, the second plate 330 (the second tab portions 331 and 332) is arranged and joined on the outside (in the X-axis negative direction) of the second current collector 420 (the second electrode assembly connection portion 422), but may be arranged in the inside (in the X-axis positive direction) thereof.

In the above example embodiment, in the forming of the first joint portion 500 (S104 in FIG. 5), resistance welding or ultrasonic bonding is exemplified as a technique for clamping and joining the first plate 320 and the first current collector 410 from both sides, but the technique is not limited thereto. The first plate 320 and the first current collector 410 may be clamped and joined from both sides by caulking joining, joining by a bolt and a nut, or another joining technique. Similarly, also in the forming of the second joint portion 600 (S110 in FIG. 5), a technique for joining the second plate 330 and the second current collector 420 from one side is not limited to laser welding, and various techniques can be adopted as appropriate.

In the above example embodiment, the first joint portion 500 and the second joint portion 600 are formed at both end portions of the electrode assembly 300, but the first joint portion 500 or the second joint portion 600 may be formed at any position of the electrode assembly 300.

In the above example embodiment, the order of the steps in the method for producing the energy storage device 10 is not particularly limited. The bending of the second plate 330 (S108 in FIG. 5) is not limited to being performed after the bending of the first plate 320 (S106 in FIG. 5) and may be performed before the bending of the first plate 320 (S106 in FIG. 5) or may be performed before the forming of the first joint portion 500 (S104 in FIG. 5). The forming of the second joint portion 600 (S110 in FIG. 5) may be performed before the forming of the first joint portion 500 (S104 in FIG. 5). The forming of the second joint portion 600 (S110 in FIG. 5) may be performed before the bending of the second plate 330 (S108 in FIG. 5). In addition, the order of the steps can be changed.

In the above example embodiment, the positive electrode plate and the positive electrode current collector are clamped and joined from both sides, and the negative electrode plate and the negative electrode current collector are joined from one side, but the negative electrode plate and the negative electrode current collector may be clamped and joined from both sides, and the positive electrode plate and the positive electrode current collector may be joined from one side.

In the above example embodiment, the electrode assembly 300 (301, 302) is a wound-type electrode assembly in which the winding axis is parallel to the lid 120. However, the electrode assembly 300 may be a wound-type electrode assembly in which the winding axis is perpendicular to the lid 120. The electrode assembly 300 may be a stacked-type (stack-type) electrode assembly formed by stacking a plurality of plate-shaped plates, may be a bellows-type electrode assembly in which the plates are folded in a bellows shape, or may be an electrode assembly of another form.

In the above example embodiment, the energy storage device 10 includes two electrode assemblies 300, but the number of the electrode assemblies 300 is not particularly limited and may be one or may be three or more.

A form constructed by optionally combining elements included in the above example embodiment and the modification examples thereof is also included within the scope of the present invention.

Example embodiments of the present invention can be applied to energy storage devices such as lithium ion secondary batteries and to methods for producing the energy storage devices.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A method for producing an energy storage device including an electrode assembly including a first plate and a second plate, a first current collector joined to the first plate, and a second current collector joined to the second plate, the method comprising:
forming a first joint portion by clamping and joining the first plate and the first current collector from both sides; and
forming a second joint portion by joining the second plate and the second current collector from one side.

2. The method for producing the energy storage device according to claim 1, wherein
the forming of the first joint portion including forming the first joint portion at one end portion of the electrode assembly in a predetermined direction; and
the forming of the second joint portion includes, after the forming of the first joint portion, forming the second joint portion at an other end portion of the electrode assembly in the predetermined direction.

3. The method for producing the energy storage device according to claim 2, further comprising bending the first plate after the forming of the first joint portion, wherein
the forming of the second joint portion is performed after the bending of the first plate.

4. The method for producing the energy storage device according to claim 3, further comprising bending the second plate, wherein
the forming of the second joint portion is performed after the bending of the second plate.

5. The method for producing the energy storage device according to claim 1, wherein
the first plate is a positive electrode plate;
the second plate is a negative electrode plate;
the first current collector is a positive electrode current collector; and
the second current collector is a negative electrode current collector.

6. An energy storage device comprising:
an electrode assembly including a first plate and a second plate;
a first current collector joined to the first plate; and
a second current collector joined to the second plate; wherein
the first plate and the first current collector include a first joint portion joined by resistance welding or ultrasonic bonding; and
the second plate and the second current collector include a second joint portion joined by laser welding.
